(19) United States
(12) Patent Application Publication
(10) Pub. No.: US 2026/0260094 A1
(43) Pub. Date: Sep. 3, 2026

(54) METHODS AND SYSTEMS FOR KNAPSACK-BASED TOKEN OPTIMIZATION IN MULTIMODAL LARGE LANGUAGE MODELS

(71) Applicant: Huawei Cloud Computing Technologies Co., Ltd., Gui'an New District (CN)

(72) Inventors: Vaden Wybert Masrani, Vancouver (CA); Mohammad Akbari, Coquitlam (CA); Yong Zhang, Richmond (CA)

(21) Appl. No.: 19/067,249

(22) Filed: Feb. 28, 2025

(51) Int. Cl. G06N 3/045; G06F 16/334; G06N 3/0475; G06N 3/0985

(52) U.S. Cl. CPC G06N 3/045; G06F 16/3344; G06N 3/0475; G06N 3/0985

(57) ABSTRACT

A method for improving the computational efficiency of a multimodal large language model (MLLM) by reducing the number of tokens/embeddings processed by the neural network of the MLLM. In particular, multimodal inputs are encoded to a shared embeddings space allowing for cross-modal comparisons of embeddings. Moreover, embeddings to feed into the neural network are selected to 1) maximize relevancy of the selected embeddings relative to a query, 2) maximize diversity (reduce redundancy) within the selected embeddings, and 3) maintain a total cost, reflective of computational costs associated with having the neural network process the embeddings, within a budget. The proposed techniques improve computational efficiency by reducing computational overhead of the neural network. Further, the proposed techniques maintain accuracy of the MLLM by maintaining relevancy of the selected embeddings relative to the query.

### BACKGROUND

Multimodal Large Language Models (MLLMs), capable of processing and understanding multiple types of input data simultaneously, represent a significant advancement in artificial intelligence (AI). These models build upon traditional language models by incorporating the ability to process images, video, audio, and other modalities alongside text, thereby enabling them to develop rich, contextual understanding across different forms of information.

In the specific domain of Video Question Answering (VideoQA), MLLMs have emerged as the state-of-the-art approach. MLLMs demonstrate remarkable capabilities in comprehending video content and responding to user queries. These models process video frames sequentially, analyze accompanying audio tracks, and interpret textual information like captions or transcripts to build a comprehensive understanding of the video content. This allows MLLMs to answer complex questions about events, relationships, and context within videos.

However, MLLMs face significant technical challenges, particularly in terms of computational efficiency and token management. The multi-modal nature of these models requires processing and storing large numbers of tokens for each modality—visual tokens for video frames, audio tokens for sound, and text tokens for queries and responses. This creates substantial computational overhead and often pushes against context window limitations, thereby necessitating careful optimization of token usage across modalities while maintaining model performance.

It would be advantageous to realize architectures and processes for using and implementing MLLMs that, at least in part, address some of these issues.

### SUMMARY

The present application proposes techniques that facilitate improving the computational efficiency of MLLMs by reducing the number of tokens/embeddings processed by the neural network of a MLLM. In particular, multimodal inputs are encoded to a shared embeddings space allowing for cross-modal comparisons of embeddings. Moreover, embeddings to feed into the neural network may be selected to 1) maximize relevancy of the selected embeddings relative to a query, 2) maximize diversity (reduce redundancy) within the selected embeddings, and 3) maintain a total cost, reflective of computational costs associated with having the neural network process the embeddings, within a budget. The proposed techniques improve computational efficiency by reducing computational overhead of the neural network. Further, the proposed techniques maintain accuracy of the MLLM by maintaining relevancy of the selected embeddings relative to the query.

In an aspect of the present disclosure, there is provided a computer-implemented method for generating output using a multimodal model. The method comprises receiving a query and associated multimodal input data. The multimodal input data includes at least two modalities. The method further comprises encoding, for each modality of the multimodal input data, that modality of the input data using a respective encoder for that modality to generate a plurality of embeddings mapped to a shared embedding space containing embeddings for all of the modalities of the input data. Moreover, the query is encoded to the shared embedding space as a query embedding. Further, a subset of the embeddings in the shared embedding space is selected. The subset is selected based on 1) distance measurements between the query embedding and respective embeddings in the shared embedding space and 2) a mapping that maps each embedding in the shared embedding space to a respective cost. The respective cost is based on the modality of the embedding. Upon selecting the subset, the selected subset of the embeddings and the query embedding is provided to a neural network in the multimodal model to generate a response to the query.

In some implementations, the distance measurements are based on at least one of cosine similarity and L2 distance.

In some implementations, the method further comprises receiving at least one parameter. The mapping is defined, at least partially, based on the at least one parameter.

In some implementations, the respective cost of an embedding is defined by a hyperparameter of the multimodal model.

In some implementations, the respective cost of an embedding is defined based on a computational cost associated with the neural network processing that embedding.

In some implementations, the computational cost is based on at least one of memory use, runtime, and processing power.

In some implementations, the subset is selected to maximize a value function. The value function measures at least relevancy of the subset relative to the query embedding. The subset is further selected to maintain a total cost within a budget. The total cost is obtained by 1) obtaining a range by applying the mapping to the subset and 2) computing at least one of a sum and an average over the range.

In some implementations, the method further comprises receiving, prior to selecting the subset, and via user selection, at least one parameter. The budget is determined based on the at least one parameter.

In some implementations, the value function comprises a coverage function that measures relevancy of the subset relative to the query embedding. The coverage function measuring relevancy by, at least 1) determining, for a first embedding of the subset, a first distance measurement between the first embedding and the query embedding, 2) determining, for a second embedding of the subset, a second distance measurement between the second embedding and the query embedding, and 3) applying a computing operation to the first distance measurement and the second distance measurement. The computing operation is one of a summing operation and an averaging operation.

In some implementations, the value function comprises a reward function configured to bias the value function toward diversity of embeddings. The reward function biases the value function based on at least an internal distance measurement between a first embedding of the subset and a second embedding of the subset.

In some implementations, selecting the subset further comprises obtaining a copy of the plurality of embeddings. A marginal embedding is identified in the copy. The marginal embedding maximizes a marginal gain per unit cost in the value function. The unit cost is computed by applying the mapping to the marginal embedding. The marginal embedding is added to a selected set of embeddings. The marginal embedding is further removed the marginal embedding from the copy.

In some implementations, the at least two modalities may include at least one of text data, audio data, and visual data.

According to another aspect of the present disclosure, there is provided a computer readable storage medium, comprising one or more instructions, wherein when the one or more instructions are run on a computer, the computer performs any of the methods disclosed herein.

According to another aspect of the present disclosure, there is provided a non-transitory computer-readable medium storing instruction the instructions causing a processor in a device to implement any of the methods disclosed herein.

According to another aspect of the present disclosure, there is provided a device configured to perform any of the methods disclosed herein.

According to another aspect of the present disclosure, there is provided a processor, configured to execute instructions to cause a device to perform any of the methods disclosed herein.

According to another aspect of the present disclosure, there is provided an integrated circuit configure to perform any of the methods disclosed herein.

According to another aspect of the present disclosure, there is provided a module comprising: one or more circuits for performing any of the methods disclosed herein.

According to another aspect of the present disclosure, there is provided an apparatus comprising: one or more processors functionally connected to one or more memories for performing any of the methods disclosed herein.

According to another aspect of the present disclosure, there is provided an apparatus configured to perform any of the methods disclosed herein.

In some embodiments, the apparatus comprises one or more units configured to perform the above-described method.

According to another aspect of the present disclosure, there is provided one or more non-transitory, computer-readable storage media comprising computer-executable instructions, wherein the instructions, when executed, cause at least one processing unit, at least one processor, or at least one circuits to perform any of the methods disclosed herein.

According to another aspect of the present disclosure, there is provided one or more computer-readable storage media storing a computer program, wherein, when the computer program is executed by an apparatus, the apparatus is enabled to implement any of the methods disclosed herein.

According to another aspect of the present disclosure, there is provided a computer program product including one or more instructions, wherein, when the instructions are executed by an apparatus, the apparatus is enabled to implement any of the methods disclosed herein.

According to another aspect of the present disclosure, there is provided a computer program, wherein, when the computer program is executed by a computer, an apparatus is enabled to implement any of the methods disclosed herein.

According to another aspect of the present disclosure, there is provided a system comprising a node for performing any of the methods disclosed herein.

### BRIEF DESCRIPTION OF THE DRAWINGS

Embodiments are described in detail below, with reference to the following drawings:

FIG. 1 illustrates a computing environment for a disclosed embodiment;

FIG. 2 is a simplified diagram illustrating an architecture for optimizing token/embedding usage of a MLLM;

FIG. 3 is another simplified diagram illustrates another architecture for optimizing token/embedding usage of a MLLM;

FIG. 4A illustrates an example computing systems, in accordance with example embodiments;

FIG. 4B illustrates a MLLM system that incorporates token/embedding usage optimization;

FIG. 5 illustrates, in flowchart form, a method for generating output using a MLLM that optimizes token/embedding usage;

FIG. 6 illustrates an algorithm for optimizing token/embedding usage of a MLLM; and

FIG. 7 illustrates, in flowchart form, another method for generating output using a MLLM that optimizes tokens/embedding usage.

Like reference numerals are used in the drawings to denote like elements and features.

### DETAILED DESCRIPTION OF EMBODIMENTS

Embodiments disclosed herein relate to systems and apparatuses using MLLMs and large language models (LLMs). The systems and apparatuses disclosed herein may comprise suitable modules and/or circuitries for executing various procedures.

As those skilled in the art understand, a “module” is a term of explanation referring to a hardware structure such as a circuitry implemented using technologies such as electrical and/or optical technologies (and with more specific examples of semiconductors) for performing defined operations or processing. A “module” may alternatively refer to the combination of a hardware structure and a software structure, wherein the hardware structure may be implemented using technologies such as electrical and/or optical technologies (and with more specific examples of semiconductors) in a general manner for performing defined operations or processing according to the software structure in the form of a set of instructions stored in one or more non-transitory, computer-readable storage devices or media.

A module may be a part of a device, an apparatus, a system, and/or the like, wherein the module may be coupled to or integrated with other parts of the device, apparatus, or system such that the combination thereof forms the device, apparatus, or system. Alternatively, the module may be implemented as a standalone device or apparatus.

The module usually executes a procedure for performing a method. Herein, a procedure has a general meaning equivalent to that of a method. More specifically, a procedure is a defined method implemented using hardware components for processing data. A procedure may comprise or use one or more functions for processing data as designed. Herein, a function is a defined sub-procedure or sub-method for computing, calculating, or otherwise processing input data in a defined manner and generating or otherwise producing output data.

As those skilled in the art will appreciate, a procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module may read the computer-executable code from the storage devices and execute the computer-executable code to perform the procedure.

Alternatively, a procedure may be implemented as one or more hardware structures having necessary electrical and/or optical components, circuits, logic gates, integrated circuit (IC) chips, and/or the like.

### Machine Learning (ML), Neural Networks, LLMs, and MLLMs

To assist in understanding the present disclosure, some concepts relevant to ML, neural networks, LLMs, and MLLMs are first discussed.

Generally, a neural network comprises a plurality of interconnected artificial neurons arranged in multiple layers, including an input layer, an output layer and, oftentimes, a hidden (intermediate) layer. The neural network is designed to process input data, extract relevant features, and generate an output based on learned patterns and correlations. An artificial neuron within the network is configured to receive one or more input signals, apply a weighted transformation to the inputs, and process the transformed data using an activation function. Output from one layer in the network may be forwarded (input) to a next layer in the network until a final output layer of the neural network. Some neural networks may have more complex mechanisms for inputting data from one layer to another than taking output from layer and providing the output to the next layer. For example, in some neural networks, a skip connection may be used to feed output of a first layer of a neural network to a second layer wherein the second layer is not the layer directly following the first layer. In another example, a feedback connection may be used to feed output of one layer in a neural network to an earlier layer. The neural network employs an adaptive learning mechanism, wherein the weights associated with connections between neurons are iteratively adjusted based on a predefined training algorithm, such as backpropagation with gradient descent or an alternative optimization technique.

A neural network may be trained using a learning methodology or a combination of learning methodologies such as supervised learning, unsupervised learning, reinforcement learning, etc. Performing the learning methodology (or combination of learning methodologies) enables the neural network to improve its performance over time by minimizing an error function or optimizing an objective criterion. Examples of supervised learning include, without limitation, naïve Bayes algorithms, regression algorithms (e.g., linear, nonlinear, logistic, polynomial, etc.), support vector machine (SVM) algorithms, K-nearest neighbor (KNN) algorithms, random forest algorithms, and deep learning algorithms. Examples of unsupervised learning include, without limitation, K-means clustering algorithms, hierarchical clustering algorithms, density-based spatial clustering of applications with noise (DBSCAN) algorithms, principal component analysis (PCA) algorithms, t-distributed stochastic neighbor embedding algorithms (t-SNE), autoencoder algorithms, isolation forest algorithms, one-class SVM algorithms, apriori algorithms, Eclat algorithms, generative adversarial network (GAN) algorithms, and deep learning algorithms. Examples of reinforcement learning include, without limitation, Q-learning algorithms, actor-critic algorithms, and policy iteration algorithms.

Applications of a neural network include, without limitation, image and speech understanding and generation, natural language processing (NLP), predictive analytics, anomaly detection, and autonomous decision-making systems. The architecture of the neural network may be customized by varying the number of layers, the type of activation functions (e.g. sigmoid function, Tanh activation function, rectified linear unit function, softmax function softplus function, etc.), connectivity patterns (e.g. skip connections, feedback connections, etc.), and training methodologies.

A deep neural network (DNN) comprising a multi-layered neural network for high-dimensional data processing, feature extraction, and predictive modeling. Examples of DNNs include, without limitation, convolutional neural networks (CNNs), recurrent neural networks (RNNs), multilayer perceptrons (MLPs), and combinations thereof. ML models are often implemented using a DNN.

Training a ML model generally involves a series of steps. Training may begin with acquiring raw input data which may undergo preprocessing steps such as data normalization, feature scaling, dimensionality reduction, missing value imputation, and augmentation techniques. In supervised learning, labelled datasets may be portioned into a training set, a validation set, and test sets. In unsupervised learning, clustering or transformation methods may be applied to the raw input data. Parameters for the ML model may then be initialized. For example, weights and biases associated with artificial neurons in the neural network, for applying weighted transformations, may be initialized. In some implementations, the parameters may be initialized using randomization, pretraining, or heuristic-based initialization techniques. During an iteration of training, a sample input is processed through the ML model, where each computational unit (artificial neuron) applies a weighted transformation followed by an activation function. The model may then generate an output which is compared against the expected result in supervised learning or, in the case of supervised or reinforcement learning, evaluated using an objection function. A loss function (e.g. mean squared error (MSE), cross-entropy loss, reinforcement learning reward functions, etc.) quantifies the discrepancy between the ML model's output and the desired outcome. To improve the ML model, (i.e. make the output closer to the desired output), optimization techniques such as stochastic gradient descent (SGD) algorithms, adaptive moment estimation (Adam), root mean square propagation (RMSprop) are used to adjust the parameters of the ML model. In some implementations, the optimization techniques may involve backpropagation wherein gradients of the loss function are computed with respect to the parameters of the ML model using the chain rule of differentiation. These gradients may guide the updating of the parameters in a direction that minimizes loss. To prevent overfitting and enhance model generalization, various regularization techniques may be applied during the training process. For example, L1 and/or L2 regularization techniques may be used to introduce a penalty to the loss function for high-value correlated coefficients. Other regularization techniques include, without limitation, data augmentation, early stopping, dropout regularization, and batch normalization

The training process involves monitoring performance of the ML model using evaluation metrics such as accuracy precision-recall, F1-score, AUC-ROC, mean absolute error (MAE), and combinations thereof. Computing the evaluation metrics may involve processing the validation set with the ML model. Further, according to the evaluation metrics, hyperparameters of the ML model (e.g., number of layers in the neural network, learning rate, etc.) may be fine-tuned. A new iteration of the training process may be performed following the finetuning of the hyperparameters of the ML model. The training process may end when improvements in the ML model plateau.

In some implementations, after completing the training process, the test set may be used for a final evaluation of the ML model. Performance of the ML model may be evaluated using the evaluation metrics.

Upon completion of the training process, the parameters and hyperparameters of the ML model may be fixed and deployed for use.

In some implementations, a trained ML model may be finetuned, for example, for a specific task. That is, the parameters of the ML model may be adjusted to improve performance with respect to the specific task. The finetuning process of the ML model is similar to the training process as described herein. Typically, the dataset used to finetune the ML model is smaller than the dataset used to train the ML model.

An LLM is a DNN-based AI system designed for NLP, text generation, contextual understanding, and multimodal interactions, among others. An LLM may be implemented using neural network architecture known as a transformer architecture or transformer. Examples of transformer-based LLMs include, without limitation, the Bidirectional Encoder Representations from Transformers (BERT) model, the Transformer-XL model, and the Generative Pre-trained Transformer (GPT) models. Transformers may take advantage of parallel processing capabilities of graphics processing units (GPUs), neural processing units (NPUs), and/or tensor processing units (TPUs) to efficiently process sequential data, thereby allowing it to perform computations efficiently.

A transformer-based LLM may tokenize input to the LLM (such as a textual prompt). That is, the LLM may generate a sequence of tokens (or plurality of tokens) based on the input. In some embodiments, the LLM may generate the tokens using an encoder, or encoding module. In an example, if the input to the transformer is a sequence of words such as “the quick brown fox,” the LLM may generate a token for each word. That is, the LLM may generate a first token corresponding to “the,” a second token corresponding to “quick,” a third token corresponding to “brown,” and a fourth token corresponding to a “fox.” Further, the encoder may generate a special token encoding contextual information such as a [CLS] token. A token may be considered a numerical representation of the corresponding word. Thus, tokenizing input to the LLM may result in a numerical sequence corresponding to the input.

Following tokenization, the transformer-based LLM may convert each token to an embedding (or vector) in an embedding space (or vector space). The embedding may be performed by an embedding layer, embedding module, or a projector. In some implementations, for example in the case of using an embedding layer, the embedding may occur within the transformer architecture. That is, the embedding layer is a layer in the transformer. In these implementations, the embedding is performed according to parameters of the transformer and the token-to-embedding mapping may change or evolve as the LLM undergoes training. In other implementations, the LLM may convert the tokens to embeddings prior to feeding the corresponding data to the transformer. In these implementations, where applicable, the terms “token” and “embedding” may be used interchangeably. Converting the tokens to embeddings may allow the LLM to have similar mathematical representations for tokens that are semantically similar (e.g., “rain” and “precipitation”).

A transformer may include an encoder layer/block. An encoder layer/block may, in response to receiving input, output embeddings (in an embedding space), vector representations (in a vector space), or features (in a feature space). In some implementations, the encoder layer/block may output the embeddings according to weighted transformations. An example of an encoder layer/block includes the embedding layer previously discussed. Another example includes a positional encoder that may add to embeddings in the embedding space, positional information related to the placement of the original token in the original sequence of tokens. The encoder layer/block may comprise a series of connected layers in the transformer.

A transformer may also include a decoder layer/block. The decoder layer/block may take in, as input, embeddings, vector representations, or features (such as the output of the encoder layer/block) and generate output. For example, given embeddings corresponding to a sequence of words, the decoder layer/block may generate output (such as a token) corresponding to a next word in the sequence. In some implementations, the decoder layer/block may feed the output back into the decoder layer/block to generate another output. That is, the decoder layer/block may continue to generate a sequence of output (tokens) by feeding the output back into the decoder layer/block. In this example, the decoder layer/block may output a special token such as a [EOS] token. The [EOS] represents an end of a sequence. Upon generating the [EOS] token, the decoder layer/block may halt generating output. The decoder layer/block may comprise a series of connected layers in the transformer.

It should be appreciated that a transformer may comprise more than one encoder layer/block and more than one decoder layer/block. Some transformers are implemented using both encoder layers/blocks and decoder layers/blocks. Such a transformer is used to implement the Text-to-Text Transfer Transformer (T5) model. Some transformers, such as BERT, are implemented with only encoder layers/blocks. Further, some transformers may be implemented using only decoder layers/blocks. A GPT model may be considered such an implementation of a transformer.

A transformer, or transformer-based LLM, may further include a generator or generating module. The generator may convert the output of the decoder layer/block (such as a sequence of tokens) to a final output for the LLM. For example, if the decoder layer/block outputted a sequence of tokens corresponding to the text “jumps over the lazy dog,” the generator may generate a sequence of words corresponding to “jumps over the lazy dog.”

A MLLM is an AI system capable of processing and integrating data from multiple modalities, such as text, images, audio, and video, to generate outputs or perform tasks that require cross-modal understanding. An example of a task requiring cross-modal understanding is generating a textual description for a video segment or providing an answer relating to a video in response to receiving a user query. MLLMs may employ a combination of deep learning architectures.

A MLLM may use modality-specific encoders/projectors to generate tokens and/or embeddings. For example, a text encoder may be used to generate tokens/embeddings corresponding to text input. Likewise, an image encoder may be used to generate embeddings corresponding to visual data such as frames of a video. Then generated tokens/embeddings may then be input to a neural network such as an LLM to generate data or perform a task.

### Optimizing Token/Embedding Usage and Knapsack Problems

To assist in understanding the present disclosure, some concepts relevant to MLLMs and token/embedding usage optimization will be discussed.

In specific embodiments, a MLLM may process a set (or plurality), denoted S, of embeddings, in a shared embedding space, obtained based on tokens generated by processing multimodal input data such as a video (e.g. frames, audio, transcript, and metadata). Further, each modality of the multimodal input data may have an associated cost. Hence, each of the set of embeddings (tokens) may also be associated with a cost. The cost of each token/embedding (modality) may be reflective of the computational cost associated with processing that token/embedding in a neural network or LLM of the MLLM. Further, the MLLM may also process a query associated with the multimodal input data and generate a query embedding, denoted Q. The query embedding is also in the shared embedding space. That is, Q and the elements of S both reside in the shared embedding space. The relevancy of an embedding in S may depend on Q. Accordingly, it is desired to improve computational efficiency of the MLLM by reducing the number of embeddings/tokens processed by the neural network. In particular, it is an objective to select a subset D wherein the relevancy of the embeddings in the subset is maximized and the total cost associated with the subset is minimized (or below a budget or threshold). This problem may be characterized as a knapsack problem wherein the goal is to maximize value in a set given constraints (e.g. a budget) to the set. Accordingly, selecting the subset may be formulated as obtaining the subset S* of S defined by:

$${S}^{*} = {arg max}_{{S}^{′} ⊆ S} ( {V}_{Q} ( {S}^{′} ) ) , {\sum }_{i ∈ {S}^{′}} {c}_{i} \leq B$$

where V_{Q} is a value function that outputs a value given an input S'⊆S, cᵢ is the cost of an embedding i, and B is a budget that the total cost associated with the selected subset cannot exceed. The budget in this context may be considered a computational cost or a maximum computational value.

Further, the value function V_{Q} may be defined by:

$${V}_{Q} ( {S}^{′} ) = {L}_{Q} ( {S}^{′} ) + λ {R}_{Q} ( {S}^{′} )$$

where L_{Q} is a “coverage” function that measures how well an input set S'⊆S covers Q, R_{Q} is a “reward” function that rewards diversity and/or penalizes redundancy among the selected embeddings, and λ is a trade-off parameter. The function L_{Q} may be understood to be a function that measures relevancy of an input set S'⊆S relative to Q (and by extension, the query).

L_{Q} may be a sum of shifted cosine similarities between embeddings and the query. Specifically, L_{Q} may be defined according to:

$${L}_{Q} ( {S}^{′} ) = {\sum }_{i ∈ {S}^{′}} \frac{1 + cos ( Q , i )}{2}$$

where cos(.,.) is a function that computes cosine similarity between embeddings. It may be understood that L_{Q} measures relevancy of the subset S* by, at least, 1) determining, for a first embedding of the subset, a first distance measurement between the first embedding and the query embedding, 2) determining, for a second embedding of the subset, a second distance measurement between the second embedding and the query embedding, and 3) summing the first distance measurement and the second distance measurement. It should be appreciated that while L_{Q}, as defined herein, is defined using summation over a plurality of distance measurements, in other embodiments, a similar coverage function may use an averaging operation. Accordingly, step 3) from above may be generalized to: 3) applying a computing operation to the first distance measurement and the second distance measurement, the computing operation being one of a summing operation and an averaging operation. It should further be appreciated that the value of L_{Q} increases as the distances between embeddings of the input set S′ and Q decreases. Accordingly, maximizing L_{Q}, which defines (partially) V_{Q}, biases selection of a subset wherein the embeddings of the subset are closer to Q. That is, the subset S* may be selected to maximize a value function wherein the value function measures, at least, relevancy of the subset relative to the query embedding Q.

R_{Q} may encourage diversity within S* by rewarding/penalizing an input set S′ based on maximum distance between the elements of S′. Specifically, R_{Q} may be defined according to:

$${R}_{Q} ( {S}^{′} ) = 1 - {\sum }_{i , {i}^{′} ∈ {S}^{′} , i \neq {i}^{′}} \frac{1 + cos ( i , {i}^{′} )}{2} .$$

It should be appreciated that the value of R_{Q} increases as the distances between embeddings of the input set S′ with each other increases. Accordingly, maximizing R_{Q}, which defines (partially) V_{Q}, biases selection of a subset wherein the embeddings of the subset are far from each other (or less redundant). That is, R_{Q} biases the value function V_{Q} toward diversity of embeddings. It may be said that L_{Q} biases V_{Q} based on an internal distance measurement between a first embedding of the subset S* and a second embedding of the subset S*.

It should be appreciated that while V_{Q}, L_{Q}, and R_{Q}, as defined herein, are defined using cosine similarity for distance measurements, in other embodiments of token/embedding optimization, similar functions use for similar purposes may be defined using distance measurement based on other types of distance metrics. For example, another coverage function may be based on L2 distance. Thus, it may be said that selection of a subset such as S* may be based on distance measurements based on at least one of cosine similarity and L2 distance.

It is further noted that V_{Q}, as defined herein, is a monotone submodular function. A submodular function is a function that outputs a value given an input set and wherein adding an element to the input set generally provides diminishing marginal returns. A monotone function is a function that outputs a value given an input set and wherein adding an element to the input set maintains or increases the value of the output. A monotone submodular function is both a submodular function and a monotone function.

cᵢ may be considered a function or mapping that maps an embedding i to an associated cost. Specifically, cᵢ may be defined according to:

$${c}_{i} = \{ \begin{matrix}{c}_{text} & if i is corresponds to text modality \\ {c}_{audio} & if i corresponds to audio modality \\ {c}_{image} & if i corresponds to image modality\end{matrix}$$

where cₜₑₓₜ, c_{audio}, c_{image are hyperparameters of the MLLM designed to be reflective of computational costs associated with a neural network processing, respectively, text, audio, and image modalities, and are thereby typically set such that}

$${c}_{text} \leq {c}_{audio} \leq {c}_{image} .$$

That is, the respective cost of an embedding may be defined based on a computational cost associated with the neural network processing the embedding. The computational cost may be based on at least one of memory use, runtime, and processing power. It is further noted that by formulating cᵢ as a mapping, the total cost of the subset S* may be obtained by 1) obtaining a range by applying the mapping to S* and 2) computing a sum over the range. It should be appreciated that while the knapsack problem, as defined herein, maintains the total is computed by summing the costs associated with the selected embeddings in S*, in other embodiments of token/embedding optimization that involve solving a similar knapsack problem, the total cost may be computed as an average of the costs associated with the selected embedding. Accordingly, step 2) from above may be generalized to: 2) computing at least one of a sum and an average over the range.

The present disclosure will now proceed to discuss selecting and/or pruning tokens to increase computational efficiency of a MLLM.

Implementing a MLLM with Token/Embedding Usage Optimization

In order to improve computational efficiency, some MLLMs may be designed to perform token reduction. Some MLLMs may perform token reduction by token pruning techniques. In these techniques, tokens, such as vision tokens corresponding to the image modality, may be pruned after the tokenization process. These techniques typically use analysis to attention score metrics to identify and prune tokens deemed less significant for model performance. Other MLLMs may perform keyframe selection techniques to perform token reduction. In these techniques, tokens, such as vision tokens corresponding to the image modality may be selected/pruned prior to the tokenization process by identifying and removing redundant or unnecessary frames through embedding similarity analysis. Drawbacks of these techniques include 1) computationally expensive and potentially performance-degrading pretraining procedures, 2) dependence on external corpora, including training sets of knowledge bases, which increase resource requirements and limits mobile applications, 3) necessity of model architecture modifications or custom neural subnetworks, reducing broad applicability, and 4) a limited focus on the optimization of the image modality, thereby neglecting potential token reduction in other modalities and cross-modal redundancies. That is, these techniques involve modifications to the architecture of the MLLM, increased computational complexity in resource-constrained environments, limited applicability to mobile applications, and missed opportunities for leveraging complimentary information between modalities.

As will be described herein, the present disclosure describes systems and method for an MLLM to improve its computational efficiency by reducing the number of tokens/embeddings processed by the neural network of the MLLM. In particular, these systems and methods involve 1) embedding multiple modalities to a shared embedding space, thereby allowing cross-modal comparisons between the tokens/embeddings corresponding to different modalities, 2) reducing redundant tokens/embeddings processed by the neural network by measuring relevancy of the embeddings in the embeddings space relative to a query, and 3) using a minimum token modality selector which maximizes relevancy to the query while minimizing the total number of tokens/embeddings processed by the neural network. Advantages of the described system and methods include, without limitation, 1) a lack of costly pretraining procedures that can degrade model performance, 2) a lack of dependence on external data sets, 3) a lack of need for modifications to the neural network architecture, and 4) leveraging complementary information between modalities to reduce redundancy between tokens/embeddings of different modalities.

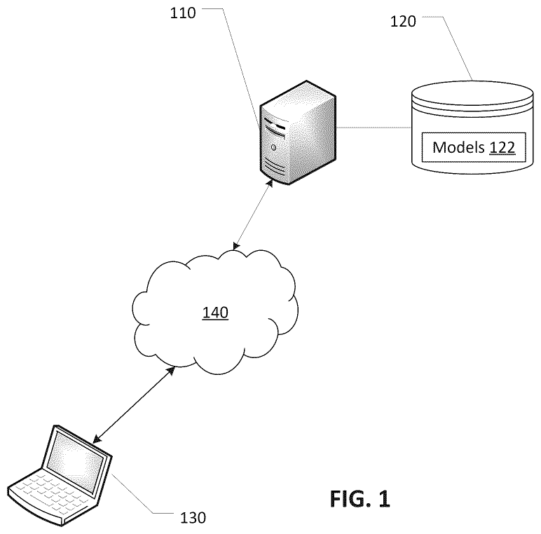

Reference is made to FIG. 1 which illustrates an example embodiment of a computing environment for providing/deploying MLLMs that perform token/embedding usage optimization to increase computational efficiency. FIG. 1 shows a computer system 110, a database 120 coupled to the computer system 110, a computing device 130, and a network 140 connecting the computer system 110 and the computing device 130.

The computer system 110 (depicted as a server) may be a computer system associated with maintaining one or more models 122 stored in the database 120. The one or more models 122 may include at least one MLLM. Further, the MLLM may enable VideoQA. The computer system 110 may access, train, use, or modify the models 122. In some embodiments, the database 120 may be integrated or internal to the computer system 110. That is, the computer system 110 may access the models 122 from an internal storage. In other embodiments, the database 120 may be remote and/or external to the computer system (e.g. a cloud server). That is, the computer system 110 may access the models 122 from a remote and/or external storage.

The computing device 130 (depicted as a laptop computer) may be a computer used by a client. Specifically, the computing device 130, or an associated client, may access or use the models 122 via a connection with the computer system 110. To this end, the computing device 130 may communicate with the computer system 110 using an application programming interface (API). In an example scenario, the computing device 130 may transmit, over the network 140, a prompt and video data to the computer system 110. The prompt may be, for example, “generate a textual summary of the provided documentary.” The computer system 110 may then pass the prompt and the video data to an MLLM included in the models 122. The MLLM may then generate, as output, a textual summary. In this example, the computing device 130 may also provide, to the computer system 110, a pruning ratio. Given the pruning ratio, the computer system 110 may cause the MLLM to reduce tokens/embeddings according to the received pruning ratio to increase computational efficiency. Additionally or alternatively, the computing device 130 may provide, to the computer system 110, customized hyperparameters that may be used to reduce tokens/embeddings. For example, the computing device 130 may provide values for cₜₑₓₜ, c_{audio}, and c_{image}, or, in the alternative, provide values that enable the computer system 110 to determine values for cₜₑₓₜ, c_{audio}, and c_{image}. The computer system 110 may then transmit the summary to the computing device 130. In this example scenario, the computing device 130 may be associated with a client that has signed a service agreement with an entity associated with the computer system 110. The service agreement may be, for example, a service agreement for access and use to the MLLM used in the described example scenario.

It should be appreciated that while FIG. 1 shows a single computing device 130, in practice, there may be multiple computing device, and associated clients, connected to the computer system 110 for access and use to the models 122.

FIG. 1 shows the network 140 connecting the computer system 110 and the computing device 130. The network 140 may be, without limitation, a wireless network, a radio network, a cellular network, an intranet, an Internet network, a 5G network, a Wi-Fi network, a local area network, a wide area network, or a combination thereof. The computer system 110 and the computing device 130 may send data and/or requests to and from each other over the network 140.

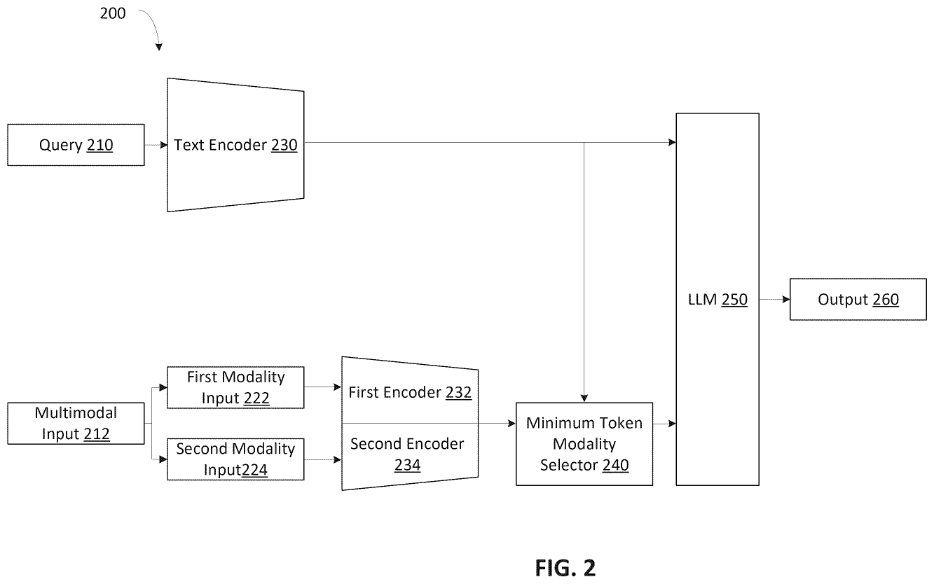

Reference is now made to FIG. 2 which shows a simplified diagram illustrating an architecture for optimizing token/embedding usage of a MLLM 200. The MLLM 200 may be a model maintained by a computer system such as the computer system 110 (see FIG. 1).

FIG. 2 shows the MLLM 200 receiving inputs. Specifically, the MLLM 200 is shown receiving a query 210 and a multimodal input 212. The query 210 may be a textual query received from, for example, a computing device such as the computing device 130 (see FIG. 1). Likewise, the multimodal input 212 may also be received from the computing device. The multimodal input 212 may include data from at least two modalities. That is, the multimodal input 212 may be split into at least a first modality input 222 and a second modality input 224. Examples of modalities that may correspond to the first modality input 222 or the second modality input 222 include, without limitation, audio, text, and frames (e.g., video frames). Additionally, or alternatively, the query 210 may be associated with the multimodal input 212. For example, the query 210 may be the prompt “identify where token reduction is discussed in this lecture” and the multimodal input 212 may be an audio recording and corresponding transcript of a lecture related to token reduction in MLLMs. That is, the first modality input 222 may be audio data of the audio recording and the second modality input 224 may be the transcript of the audio recording.

FIG. 2 further shows the MLLM 200 including a text encoder 230, a first encoder 232, and a second encoder 234. The text encoder 230 transforms the query 210 to a query embedding in a shared embedding space. That is, the text encoder may be considered to take in, as input, the query 210 and output Q. The first encoder 232 and the second encoder 234 are encoders that are specific to the first modality and the second modality, respectively. The first encoder 232 may take in, as input, the first modality input 222, and output embeddings in the shared embedding space. Likewise, the second encoder 234 may take in, as input, the second modality input 224, and output embeddings in the shared embedding space. In some embodiments, the first encoder 232 and the second encoder 234 may be components of a modality embedder block. The modality embedder block may comprise multiple modality-specific encoders that map inputs to the shared embedding space. Since the query 210, the first modality input 222, and the second modality input 224 are mapped to the shared embedding space, the various inputs may be compared to each other for the purposes of token/embedding reduction. For example, the first modality input 222 and the second modality input 224 may be compared to the query 210 to measure relevancy of the tokens/embeddings of the first modality input 222 and the second modality input 224 relative to the query 210. Further, the tokens/embeddings of the first modality input 222 and the second modality input 224 may be compared against each other to reduce cross-modal redundancy among the tokens/embeddings.

It should be appreciated that the text encoder 230, the first encoder 232, and the second encoder 234 may perform both 1) tokenization of the query 210, first modality input 222, and second modality input 224 and 2) outputting/generating, based on the tokens generated via the tokenization process, embeddings in the shared embedding space. It should further be appreciated that an embedding may correspond to a token (e.g., because a token may be converted to an embedding) and thus, reducing tokens may correspond to reducing embeddings and vice versa. Accordingly, where applicable, the terms “token” and “embedding” may be used interchangeably throughout the present disclosure.

FIG. 2 further shows the MLLM 200 including a minimum token modality selector 240. The minimum token modality selector 240 may select embeddings (outputted by the first encoder 232 and the second encoder 234) to be processed by the LLM 250. In particular, the minimum token modality selector 240 may select the embeddings so as to 1) maximize relevancy of the selected embeddings relative to the query 210 (or its corresponding embedding outputted by the text encoder 230), 2) minimize information redundancy between the selected tokens, and 3) maintain a total cost below a budget. The minimum token modality selector 240 may be said to select the tokens by solving the knapsack problem as described herein.

Upon selection of the embeddings by the minimum token modality selector 240, the query embedding Q (outputted by the text encoder 230) and the embeddings selected by the minimum token modality selector 240 may be fed to the LLM 250 to generate the output 260. In the example where the query 210 is “identify where token reduction is discussed in this lecture,” the output 260 may be a textual sequence identifying a start time and an end time in the audio recording of the lecture. For example, the output 260 may be “00:36:21 to 00:43:38.”

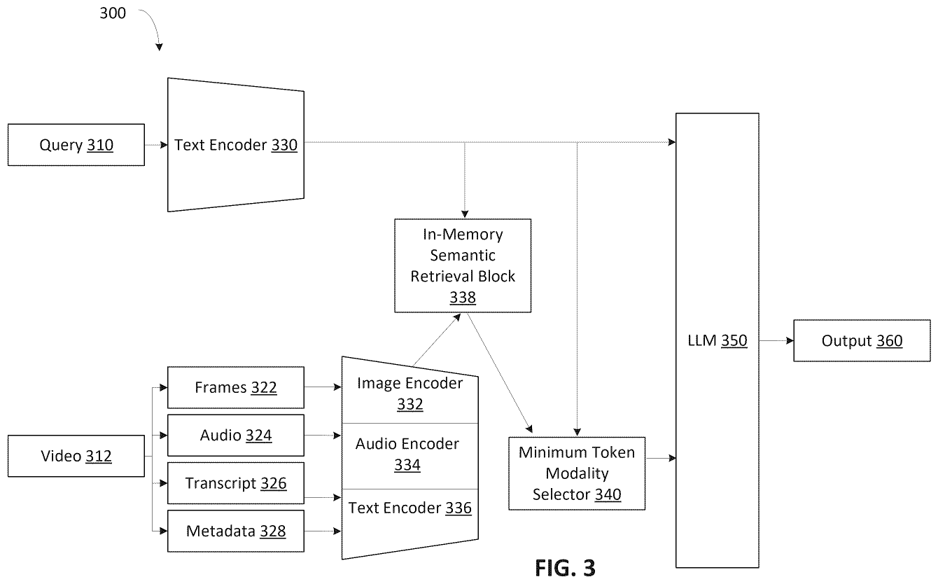

Reference is now made to FIG. 3 which shows a simplified diagram illustrating an architecture for optimizing token/embedding usage of a MLLM 300. The MLLM 300 may be a model maintained by a computer system such as the computer system 110 (see FIG. 1). As will be described, the MLLM 300 is similar to the MLLM 200 (see FIG. 2). In fact, the MLLM 300 may be considered a specific implementation of the MLLM 200.

FIG. 3 shows the MLLM 300 receiving inputs. Specifically, the MLLM 300 is shown receiving, as input, a query 310 and a video 312. The query 310 may be similar to the query 210 as described with reference to FIG. 2. The video 312 is likewise similar to the multimodal input 212 as described herein with reference to FIG. 2. As with the query 210 and the multimodal input 212, the query 310 and the video 312 may be associated. For example, the query 310 may be “What is the license plate of the fastest car in this video clip?” and the video 312 may be the corresponding video clip.

FIG. 3 shows the video 312 being divided into its various modalities, namely, frames 322, audio 324, and text (a transcript 326, and metadata 328). The frames 322, the audio 324, the transcript 326, and the metadata 328 may be comparable to the first modality input 222 and the second modality input 224 as described herein with reference to FIG. 2.

FIG. 3 further shows a text encoder 330 that outputs a query embedding in a shared embedding space as a result of processing the query 310. The text encoder 330 may operate and function similarly to the text encoder 230 as described herein with reference to FIG. 3. FIG. 3 also shows an image encoder 332, an audio encoder 334, and a text encoder 336 that likewise output, by processing inputs from a corresponding modality, embeddings in the shared embedding space. The image encoder 332, the audio encoder 334, and the text encoder 336 may operate and function similarly to the first encoder 232 and the second encoder 234 as described herein with reference to FIG. 2. It should be appreciated that in some embodiments, the text encoder 330 and the text encoder 336 may be the same encoder.

FIG. 3 further shows an in-memory semantic retrieval block 338. The in-memory semantic retrieval block 338 utilizes a vector database to store and retrieve embeddings efficiently. By employing cosine similarity, the in-memory semantic retrieval block 338 may quickly identify embeddings that are similar to the query embedding. This retrieval process may be essential for pinpointing relevant content across different modalities, thereby enabling the MLLM 300 to respond accurately and promptly to the received input (the query 310 and the video 312).

FIG. 3 further shows the MLLM 300 including a minimum token modality selector 340 for selecting embeddings to feed to an LLM 350. The minimum token modality selector 340 may operate and function similarly to the minimum token modality selector 240 as described herein with reference to FIG. 2.

Upon selection of the embeddings by the minimum token modality selector 340, the query embedding Q (outputted by the text encoder 330) and the embeddings selected by the minimum token modality selector 340 may be fed to the LLM 350 to generate the output 360. In the example where the query 310 is “What is the license plate of the fastest car in this video clip?,” the output 360 may be a textual representation of a license plate identified in the video 312.

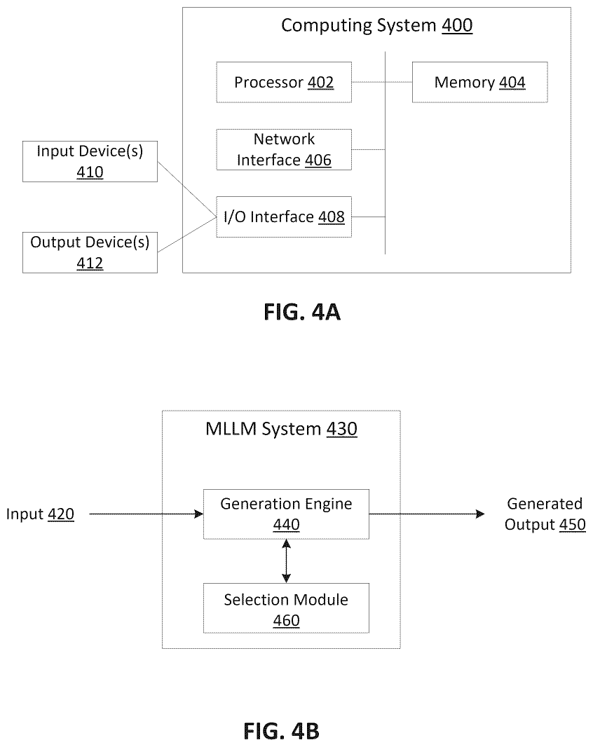

Reference is now made to FIG. 4A which illustrates an example computing system 400, which may be used to implement examples of the present disclosure, such as the MLLM 300 (see FIG. 3). Additionally or alternatively, one or more instances of the example computing system 400 may be employed to execute an MLLM. For example, a plurality of instances of the example computing system 400 may cooperate to provide output using a MLLM. Further, the example computing system 400 may be exemplary of the computer system 110 or the computing device 130 (see FIG. 1).

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated AI processor unit, a GPU, a TPU, a NPU, a hardware accelerator, or combinations thereof. The memory 404 may include a volatile or non-volatile memory (e.g., a flash memory, a random-access memory (RAM), and/or a read-only memory (ROM)). The memory 404 may be a non-transitory computer-readable medium storing instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input devices 410 and/or output device(s) 412 may be an internal component of the computing system 400.

Reference is now made to FIG. 4B which illustrates an example MLLM system 430. The MLLM system 430 is configured to generate output such as sequences (e.g., text) with an LLM. The components of the MLLM system 430 may collectively implement various token/embedding reduction techniques in accordance with the presently disclosed embodiments. The MLLM system 430 includes a generation engine 440 and a selection module 460. The generation engine 440 processes input 420, such as input prompts, text input, and visual input, provided by the user and generates output 450 based on the input 420. The generation engine 440 is communicably coupled to the selection module 460. The selection module 460 is configured to reduce tokens/embeddings in accordance with the embodiments described herein. In some embodiments, the generation engine may include a neural network including hidden layers, encoder layers, decoder layers, etc. of a MLLM and/or LLM. In some embodiments, the selection module 460 may perform functions similar to the minimum token modality selector 240 and the minimum token modality selector 340 as described herein with reference to FIGS. 2 and 3.

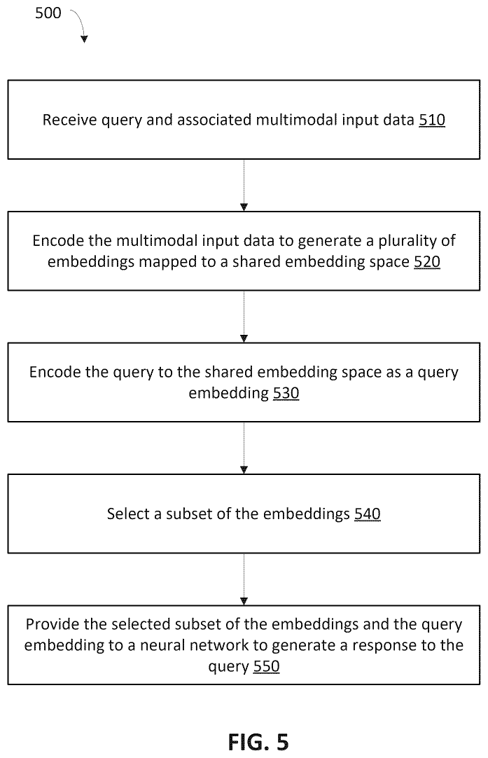

Reference is now made to FIG. 5 which shows, in flowchart form, a method 500 for generating output using a MLLM that optimizes token/embedding usage. The method 500 may be implemented by a computing device having suitable processor-executable instructions for causing the computing device to carry out the described operations. The method 500 may be implemented, in whole or in part, by a computer system such as the computer system 110, the computer system 400, or the MLLM system 430 (see FIGS. 1, 4A and 4B). As setup to the method 500, the computer system may maintain a MLLM and computing devices (such as the computing device 130), or associated clients, may access or use the MLLM by communicating with the computer system.

The method 500 begins with an operation 510. At the operation 510, the system receives a query and associated multimodal input data. The multimodal input data may include at least two modalities. In a specific embodiment, the at least two modalities may include at least one of text data, audio data, and visual data. Examples of the query include the query 310 and examples of the multimodal input data include the video 312 (see FIG. 3). In some embodiments, the query and the associated multimodal input data may be received from a computing device, or an associated client. For example, the computing device 130 may send the query and the multimodal input data to the computer system 110.

Following the operation 510, the method 500 may proceed to an operation 520. At the operation 520, the system may encode the multimodal input data to generate a plurality of embeddings mapped to a shared embedding space. The system may generate the plurality of embeddings by encoding, for each modality of the multimodal input data, that modality of the input data using a respective encoder for that modality. Further, the shared embedding space may contain embeddings for all of the modalities of the multimodal input data. The system may perform the operation 520 using modality-specific encoders such as the image encoder 332 and the audio encoder 334 (see FIG. 3). In some embodiments, the plurality of embeddings may be the set S as described herein.

Following the operation 520, the method 500 may proceed to an operation 530. At the operation 530, the system may encode the query to the shared embedding space as a query embedding in the shared embedding space. The system may perform the operation 530 using a text encoder such as the text encoder 330 (see FIG. 3). In some embodiments, the query embedding may be the embedding Q as described herein. It should be appreciated that while the FIG. 5 shows operations 520 and 530 in sequence with the operation 520 preceding the operation 530, the operations 520 and 530 may be performed in any order, simultaneously, or near-simultaneously.

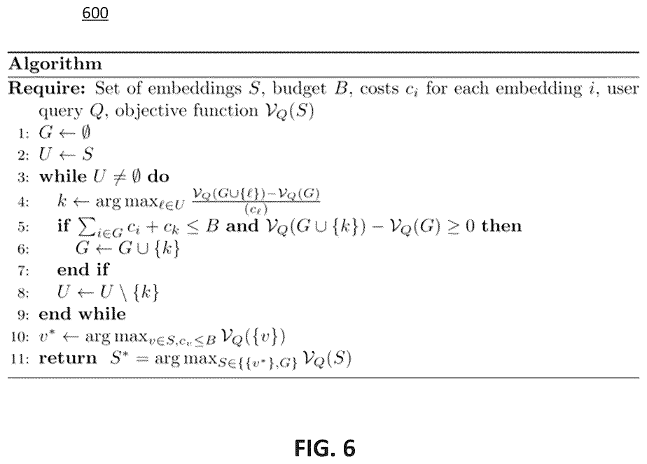

Following the operation 530, the method 500 may proceed to an operation 540. At the operation 540, the system may select a subset of the embeddings in the shared embedding space. In some embodiments, the selected subset may be the subset S* as described herein. The system may select the subset based on 1) distance measurements between the query embeddings and respective embeddings in the shared embedding space and 2) a mapping that maps each embedding in the shared embeddings space to a respective cost. The respective cost may be based on the modality the corresponding embedding. In particular, the subset may be selected so as to 1) maximize relevancy of the embeddings in the subset relative to the query (may be formulated as minimizing distance measurements between the embeddings in the subset and the query embedding), 2) minimize redundancy of embeddings within the subset, and 3) maintain a total cost below a budget. Example details related to the process of selecting the subset will be described below with reference to FIG. 6.

Following the operation 540, the method 500 may proceed to an operation 550. At the operation 550, the system may provide the selected subset of the embeddings and the query embedding to a neural network in the MLLM, such as an LLM, to generate a response to the query.

Upon generating the response, the system may send the response to the computing device, or an associated client. For example, in the case that the computing device is using or accessing the MLLM and input data (the query and the multimodal input data) is received from the computing device to this end, the response may be sent to the computing device.

As described herein, the method 500 includes selecting a subset of the embeddings at the operation 540 so as to 1) maximize relevancy of the embeddings in the subset relative to the query (may be formulated as minimizing distance measurements between the embeddings in the subset and the query embedding), 2) minimize redundancy of embeddings within the subset, and 3) maintain a total cost below a budget. An embodiment for selecting the subset will now be discussed with reference to FIG. 6 which depicts an algorithm 600 for selecting the subset of the embeddings.

As discussed previously, the object of the algorithm 600 is to select a subset S* of the set S where S is the plurality of embeddings (e.g., generated at the operation 520 of the method 500 as described with reference to FIG. 5) by solving a knapsack problem. That is:

$${S}^{*} = {arg max}_{{S}^{′} ⊆ S} ( {V}_{Q} ( {S}^{′} ) ) , {\sum }_{i ∈ {S}^{′}} {c}_{i} \leq B$$

where V_{Q} is the value function that outputs a value given an input S'⊆S, cᵢ is the cost of an embedding i, and B is a budget that the total cost associated with the selected subset cannot exceed.

As discussed previously, V_{Q} is a value function defined according to:

$${V}_{Q} ( {S}^{′} ) = {L}_{Q} ( {S}^{′} ) + λ {R}_{Q} ( {S}^{′} ) ,$$

$${L}_{Q} ( {S}^{′} ) = {\sum }_{i ∈ {S}^{′}} \frac{1 + cos ( Q , i )}{2} ,$$

$${R}_{Q} ( {S}^{′} ) = 1 - {\sum }_{i , {i}^{′} ∈ {S}^{′} , i \neq {i}^{′}} \frac{1 + cos ( i , {i}^{′} )}{2} .$$

Further, as discussed previously, cᵢ may be defined according to:

$${c}_{i} = \{ \begin{matrix}{c}_{text} & if i is corresponds to text modality \\ {c}_{audio} & if i corresponds to audio modality \\ {c}_{image} & if i corresponds to image modality\end{matrix} .$$

It is further noted that the algorithm 600 is a greedy algorithm. Moreover, given that V_{Q} is a monotone submodular function, the algorithm 600 solves the discussed knapsack problem near-optimally.

The algorithm 600 begins at line 1. At line 1, a set G is set to be the empty set. G may be understood to be a working set to add embeddings of S to. As the algorithm 600 proceeds, embeddings of S are added to G until G potentially becomes the desired S*.

Following the line 1, the algorithm 600 proceeds to line 2. At line 2, a set U is initialized to equal S. That is, a copy (U) of the plurality of embeddings (S) is obtained. Similar to G, U may be understood to be a working set for the purposes of the algorithm 600. Unlike G, embeddings in U are removed from U as the algorithm 600 proceeds. Thus, while U is initialized to be a copy of S, as the algorithm 600 proceeds, U will diverge from S.

Following line 2, the algorithm proceeds to a loop at lines 3-9. As can be seen at line 3, the loop continues to execute until U is empty. Once U is empty, the algorithm will proceed to line 10. Within the loop, as seen at line 4, an embedding k∈U is obtained wherein:

$$k = {arg max}_{l ∈ U} \frac{{V}_{Q} ( G ⋃ \{ l \} ) - {V}_{Q} ( G )}{{c}_{l}} .$$

That is, k∈U maximizes the marginal gain in V_{Q} per unit cost. In other words, k maximizes the ratio of improvement in V_{Q} relative to the cost associated with k. As shown in the formula above, marginal gain is computed as the increase in the output of V_{Q} by adding k to G and dividing the increase by the cost of k as computed by applying the mapping cᵢ to k. Line 4 may be understood to be an operation comprising identifying a marginal embedding (k) in the copy (U) wherein the marginal embedding maximizes a marginal gain per unit cost in the value function (V_{Q}). Further, the unit cost may be computed by applying the mapping (cᵢ) to the marginal embedding.

Following line 4, and still within the loop, the algorithm 600 proceeds to lines 5-7. At lines 5-7, two conditions are checked. The first condition checked is that the cost of adding k to G (cₖ) keeps the total cost of G within the budget B. The total cost of G is computed by summing the cost of each element of G. The second condition checked is that adding k to G increase or maintains the value of V_{Q} when applied to G. In other words, the second condition checks that the improvement in the value of V_{Q} obtained by adding k to G is non-negative. It should be appreciated that, in some embodiments, there is no need to check the second condition. For example, if V_{Q} is a monotone function (which is the case for V_{Q} as defined herein), adding an element to a set cannot decrease the value obtained by applying V_{Q} to the set. If the two conditions are satisfied, at line 6, k is added to G. That is, the marginal embedding (k) is added to a selected set of embeddings (G).

Following the checking and potential addition of k to G at lines 5-7, the algorithm proceeds to line 8. At line 8, k is removed from U. That is, the marginal embedding (k) is removed from the copy (U). At this point, if U is non-empty, the algorithm 600 proceeds to the beginning of the loop and executes line 4 again. That is, the algorithm 600 executes another iteration of the loop. If, on the other hand, U is empty, the algorithm proceeds to line 10.

At line 10, an embedding v*∈S is obtained. In particular:

$${v}^{*} = {arg max}_{v ∈ S , {c}_{v} \leq B} {V}_{q} ( \{ v \} ) .$$

That is, v* is the embedding in S that 1) maximizes the value of V_{Q} when V_{Q} is applied to single-element subsets of S while 2) having a cost cᵥ* that is within the budget B. v* may be understood to be the single best item in S.

Following line 10, the algorithm 600 proceeds to line 11. At line 11, V_{Q} is applied to G and {v*}. S* is then set to be whichever of the two sets that outputs a greater value when input to V_{Q}.

Taken as a whole, the algorithm 600 may be understood to perform selection of the subset S* by, at least, 1) obtaining a copy (U) of the plurality of embeddings (S), 2) identifying a marginal embedding k, in the copy wherein the marginal embedding maximizes a marginal gain per unit cost in the value function.

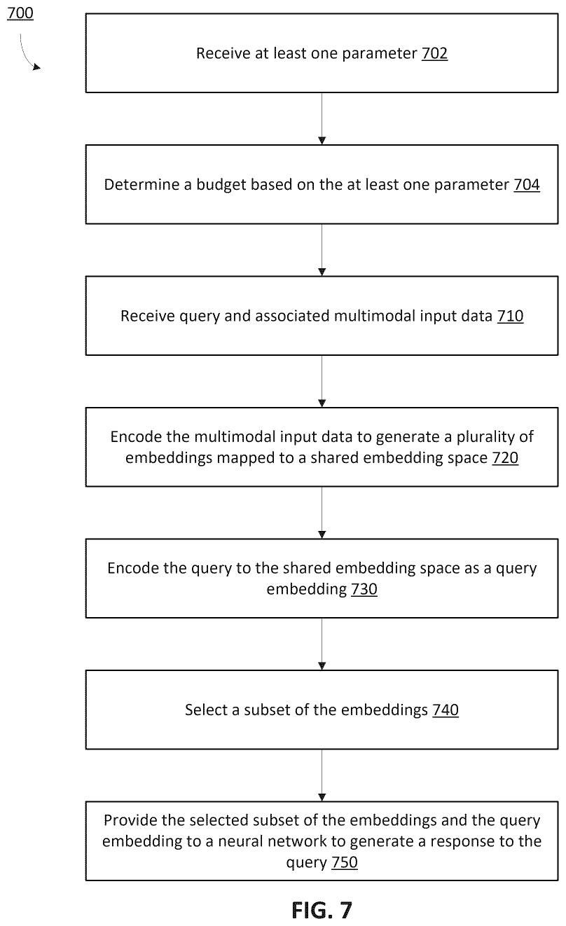

Reference is now made to FIG. 7 which illustrates, in flowchart form, another method 700 for generating output using a MLLM that optimizes tokens/embedding usage. The method 700 may be implemented by a computing device having suitable processor-executable instructions for causing the computing device to carry out the described operations. The method 700 may be implemented, in whole or in part, by a computer system such as the computer system 110, the computer system 400, or the MLLM system 430 (see FIGS. 1, 4A and 4B). As setup to the method 700, the computer system may maintain a MLLM and computing devices (such as the computing device 130), or associated clients, may access or use the MLLM by communicating with the computer system.

The method 700 begins with an operation 702. At the operation 702, the system receives at least one parameter. The at least one parameter may be received from the computing device. For example, the computing device may provide the at least one parameter to customize performance of the MLLM. For example, the at least one parameter may include a budget (such as the budget B), or alternatively, data that may be used to determine the budget B (such as a pruning ratio). Additionally or alternatively, the at least one parameter may include cost data. The system may define, at least partially, and based on the at least one parameter, the mapping cᵢ. For example, the computing device may provide, to the system, desired values for c_{image}, c_{audio}, and/or cₜₑₓₜ. Alternatively, the computing device may provide, to the system, guidance for determining the values of for c_{image}, c_{audio}, and/or cₜₑₓₜ. The guidance may be, for example, a condition, such as c_{image}>c_{audio}>cₜₑₓₜ, or a ratio comparing c_{image} to cₜₑₓₜ. It is further noted that the at least one parameter may be received via user selection. For example, the system may cause the computing device to display selectable options for a budget or costs for the MLLM. The computing device, or an associated client, may select one of the options to provide the at least one parameter to the system.

Following the operation 702, the method 700 may proceed to the operation 704. At the operation 704, as discussed previously with respect to the operation 702, the system may determine a budget based on the at least one parameter.

Following the operation 704, the method 700 may proceed to the operation 710. At the operation 710, the system may receive a query and associated multimodal input data. The system may perform the operation 710 similarly to the operation 510 of the method 500 as described herein with reference to FIG. 5.

Following the operation 710, the method 700 may proceed to the operation 720. At the operation 720, the system may encode the multimodal input data to generate a plurality of embeddings mapped to a shared embedding spaced. The system may perform the operation 720 similarly to the operation 520 of the method 500 as described herein with reference to FIG. 5.

Following the operation 720, the method 700 may proceed to the operation 730. At the operation 730, the system may encode the query to the shared embedding space as a query embedding. The system may perform the operation 730 similarly to the operation 530 of the method 500 as described herein with reference to FIG. 5.

Following the operation 730, the method 700 may proceed to the operation 740. At the operation 740, the system may select a subset of the plurality of embeddings. The system may perform the operation 740 similarly to the operation 540 of the method 500 as described herein with reference to FIG. 5.

Following the operation 740, the method 700 may proceed to the operation 750. At the operation 750, the system may provide the selected subset of the embeddings and the query embedding to a neural network of the MLLM to generate a response to the query. The system may perform the operation 750 similarly to the operation 550 of the method 500 as described herein with reference to FIG. 5.

In some implementations, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some implementations, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some implementations, an apparatus may not have any processors or computer-readable storage devices or media. Rather, the apparatus may comprise any other suitable physical or virtual components for implementing the methods disclosed herein.

In some implementations, the computer-executable instructions that implement the methods disclosed herein may be one or more computer programs, one or more program products, or a combination thereof.

In some implementations, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

1. A computer-implemented method for generating output using a multimodal model, the method comprising:
receiving a query and associated multimodal input data, the multimodal input data including at least two modalities;
encoding, for each modality of the multimodal input data, that modality of the input data using a respective encoder for that modality to generate a plurality of embeddings mapped to a shared embedding space containing embeddings for all of the modalities of the input data;
encoding the query to the shared embedding space as a query embedding;
selecting a subset of the embeddings in the shared embedding space based on:
distance measurements between the query embedding and respective embeddings in the shared embedding space; and
a mapping that maps each embedding in the shared embedding space to a respective cost, the respective cost being based on the modality of that embedding; and
providing the selected subset of the embeddings and the query embedding to a neural network in the multimodal model to generate a response to the query.

2. The computer-implemented method of claim 1 wherein the distance measurements are based on at least one of cosine similarity and L2 distance.

3. The computer-implemented method of claim 1 wherein the method further comprises:
receiving at least one parameter; and
defining the mapping, at least partially, based on the at least one parameter.

4. The computer-implemented method of claim 1 wherein the respective cost of an embedding is defined by a hyperparameter of the multimodal model.

5. The computer-implemented method of claim 1 wherein the respective cost of an embedding is defined based on a computational cost associated with the neural network processing that embedding.

6. The computer-implemented method of claim 5 wherein the computational cost is based on at least one of memory use, runtime, and processing power.

7. The computer-implemented method of claim 1 wherein the subset is selected to:
maximize a value function, the value function measuring at least relevancy of the subset relative to the query embedding; and
maintain a total cost within a budget, the total cost being obtained by:
obtaining a range by applying the mapping to the subset; and
computing at least one of a sum and an average over the range.

8. The computer-implemented method of claim 6 wherein the method further comprises:
receiving, prior to selecting the subset, and via user selection, at least one parameter; and
determining the budget based on the at least one parameter.

9. The computer-implemented method of claim 6 wherein the value function comprises a coverage function that measures relevancy of the subset relative to the query embedding, the coverage function measuring relevancy by, at least:
determining, for a first embedding of the subset, a first distance measurement between the first embedding and the query embedding;
determining, for a second embedding of the subset, a second distance measurement between the second embedding and the query embedding; and
applying a computing operation to the first distance measurement and the second distance measurement, the computing operation being one of a summing operation and an averaging operation.

10. The computer-implemented method of claim 6 wherein the value function comprises a reward function configured to bias the value function toward diversity of embeddings, the reward function biasing the value function based on at least an internal distance measurement between a first embedding of the subset and a second embedding of the subset.

11. The computer-implemented method of claim 6 wherein selecting the subset further comprises:
obtaining a copy of the plurality of embeddings;
identifying a marginal embedding in the copy, the marginal embedding maximizing a marginal gain per unit cost in the value function, the unit cost being computed by applying the mapping to the marginal embedding;
adding, the marginal embedding to a selected set of embeddings; and
removing the marginal embedding from the copy.

12. The computer-implemented method of claim 1 wherein the at least two modalities include at least one of text data, audio data, and visual data.

13. A computer system for generating output using a multimodal model, the computer system comprising:
a processor;
a memory storing instructions that, when executed the processor, cause the processor to:
receive a query and associated multimodal input data, the multimodal input data including at least two modalities;
for each modality of the multimodal input data, encode that modality of the input data using a respective encoder for that modality to generate a plurality of embeddings mapped to a shared embedding space containing embeddings for all of the modalities of the input data;
encode the query to the shared embedding space as a query embedding;
select a subset of the embeddings in the shared embedding space based on:
distance measurements between the query embedding and respective embeddings in the shared embedding space; and
a mapping that maps each embedding in the shared embedding space to a respective cost, the respective cost being based on the modality of that embedding; and
provide the selected subset of the embeddings and the query embedding to a neural network in the multimodal model to generate a response to the query.

14. The computer system of claim 11 wherein the distance measurements are based on at least one of cosine similarity and L2 distance.

15. The computer system of claim 11 wherein the respective cost of an embedding is defined based on a computational cost associated with the neural network processing that embedding.

16. The computer system of claim 11 wherein the subset is selected to:
maximize a value function, the value function measuring at least relevancy of the subset relative to the query embedding; and
maintain a total cost within a budget, the total cost being obtained by:
obtaining a range by applying the mapping to the subset; and
computing at least one of a sum and an average over the range.

17. The computer system of claim 15 wherein the value function comprises a coverage function that measures relevancy of the subset relative to the query embedding, the coverage function measuring relevancy by, at least:
determining, for a first embedding of the subset, a first distance measurement between the first embedding and the query embedding;
determining, for a second embedding of the subset, a second distance measurement between the second embedding and the query embedding; and
applying a computing operation to the first distance measurement and the second distance measurement, the computing operation being one of a summing operation and an averaging operation.

18. The computer system of claim 15 wherein the value function comprises a reward function configured to bias the value function toward diversity of embeddings, the reward function biasing the value function based on at least an internal distance measurement between a first embedding of the subset and a second embedding of the subset.

19. The computer system of claim 15 wherein selecting the subset further comprises:
obtaining a copy of the plurality of embeddings;
identifying a marginal embedding in the copy, the marginal embedding maximizing a marginal gain per unit cost in the value function, the unit cost being computed by applying the mapping to the marginal embedding;
adding, the marginal embedding to a selected set of embeddings; and
removing the marginal embedding from the copy.

20. A non-transitory computer-readable medium storing processor-executable instructions that, when executed by a processor, cause the processor to:
receive a query and associated multimodal input data, the multimodal input data including at least two modalities;
for each modality of the multimodal input data, encode that modality of the input data using a respective encoder for that modality to generate a plurality of embeddings mapped to a shared embedding space containing embeddings for all of the modalities of the input data;
encode the query to the shared embedding space as a query embedding;
select a subset of the embeddings in the shared embedding space based on:
distance measurements between the query embedding and respective embeddings in the shared embedding space; and
a mapping that maps each embedding in the shared embedding space to a respective cost, the respective cost being based on the modality of that embedding; and
provide the selected subset of the embeddings and the query embedding to a neural network in the multimodal model to generate a response to the query.
